(19) United States
(12) Patent Application Publication
(10) Pub. No.: US 2003/0115079 A1
(43) Pub. Date: Jun. 19, 2003

(54) Method of and system for ranking optimal values

(76) Inventor: Martin M. Rapaport, Las Vegas, NV (US)

Correspondence Address: Kirschstein, Ottinger,, Israel & Schiffmiller, P.C., 489 Fifth Avenue, New York, NY, 10017-6105, US

(21) Appl. No.: 10/218,841

(22) Filed: Aug. 14, 2002

Related U.S. Application Data
(60) Provisional application No. 60/315,991, filed on Aug. 30, 2001.

(51) Int. Cl. G06F 17/60

(52) U.S. Cl. 705/1

(57) ABSTRACT

Transactions are ranked in order of their value in an on-line computer network by comparing a quoted price for each transaction with an adjusted transaction price which is obtained after adjusting a suggested transaction price based on expert assessment.

### CROSS-REFERENCE TO RELATED APPLICATIONS

This application claims the priority benefit of U.S. Provisional Patent Application Serial No. 60/315,991, filed Aug. 30, 2001.

### BACKGROUND OF THE INVENTION

1. Field of the Invention

The present invention generally relates to a method of, and a system for, ranking transactions in order of their value to enable a purchaser to select the transaction with the highest ranking or optimal value.

2. Description of the Related Art

It is known to publish price lists for various items, such as diamonds, automobiles, and real estate, just to mention a few possibilities. Such published price lists generally serve as a starting point for negotiations, and generally do not reflect the list price which is arrived at after negotiation between a buyer and a seller.

It is also known to launch search programs on a global network of interconnected computers to examine price databases and retrieve prices for a specific item. A buyer can select the specific price based on a multitude of factors, including the lowest price.

### SUMMARY OF THE INVENTION

### Objects of the Invention

Accordingly, it is a general object of this invention to rank transactions in order of their value to enable a buyer to select the transaction having the optimal value.

More particularly, it is an object of the present invention to provide a novel method of, and system for, ranking transactions in order of their value based on expert assessments.

### Features of the Invention

In keeping with the above objects and others which will become apparent hereinafter, one feature of the present invention resides, briefly stated, in a method of, and a system for, ranking transactions in order of their value, comprising entering parameters concerning a first transaction in a database served by an on-line global network of interconnected computers, and retrieving from the database a suggested price for the first transaction based on the entered parameters. Thereupon, the suggested price is adjusted based on expert assessment to obtain an adjusted price for the first transaction. The expert assessment can include such factors as trade discounts, trade mark-ups, market conditions, and market locations. Thereupon, the adjusted price is compared with a quoted price to obtain a transaction value for the first transaction. The transaction value is then stored for future use.

The above steps are repeated for other transactions, thus creating a store of transaction values for multiple transactions. These stored transaction values are ranked in order of their worth and are communicated to the buyer, for example, by being displayed on a computer screen connected to the global network. The buyer will be assigned a reserved site at which the transaction values for all the transactions are stored.

The buyer may then complete the transaction by selecting the transaction having the highest ranking or optimal value. Different transactions are thus analyzed to enable the buyer to obtain the best deal.

The novel features which are considered as characteristic of the invention are set forth herein. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a screen shot of a computer screen on a buyer's computer terminal at which the buyer enters parameters concerning a transaction, in this case, a diamond purchase;

FIG. 2 is a screen shot of a ranking of multiple transactions in order of their worth;

FIG. 3 is a representative part of a database showing suggested transaction prices;

FIG. 4 is a representative part of another database showing price adjustments based on expert assessments; and

FIG. 5 is a representative part of still another database showing additional price adjustments, again based on expert assessments.

### DETAILED DESCRIPTION OF THE PREFERRED EMBODIMENTS

The following description of the invention is based on ranking diamonds in order of their worth. It will be understood that the invention is not intended to be limited to ranking diamonds, but is equally well applicable to ranking any item of personal or real property, any service, and, in brief, any transaction, including bartered and/or leased transactions between and among parties, including individuals and businesses.

A buyer, for example, wishing to obtain the best value or deal on purchasing a diamond will go to a diamond merchant or jeweler and obtain a quoted price on the diamond of interest, as well as certain parameters or factors describing the diamond. These parameters include the shape, size, color and clarity of the diamond. Sometimes, the merchant will provide a grading report, or the buyer may obtain the grading report from a gem trade laboratory. The grading report typically provides the depth, table, girdle and culet proportions of the diamond, as well as the polish, symmetry and fluorescence of the diamond, and, of course, the measurements and weight of the diamond.

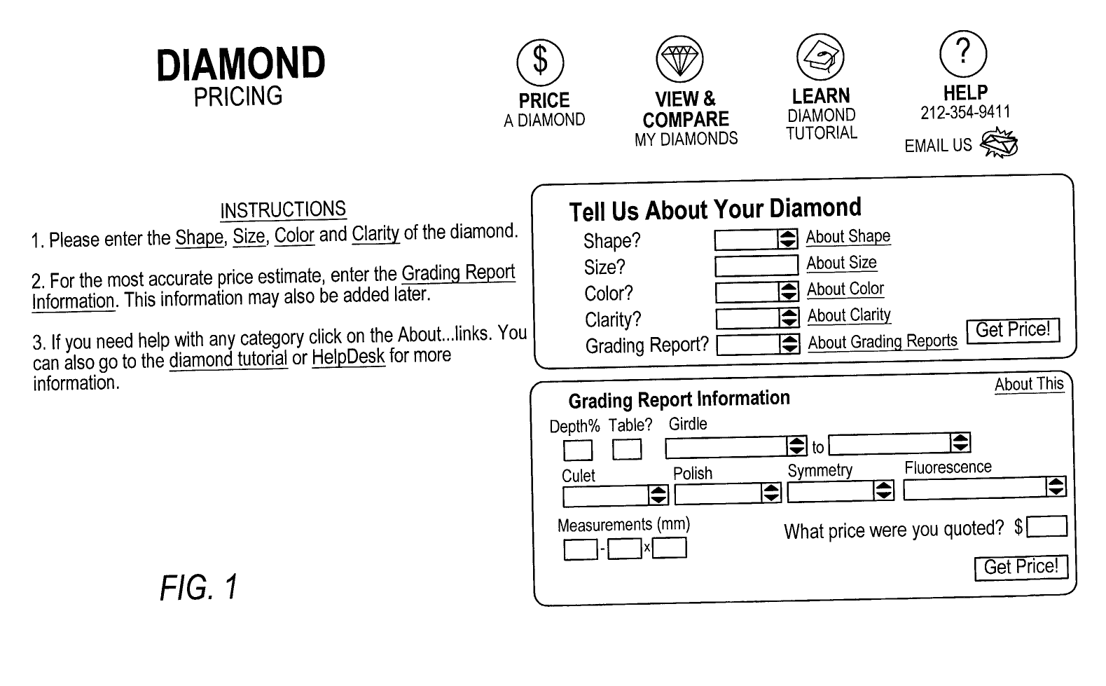

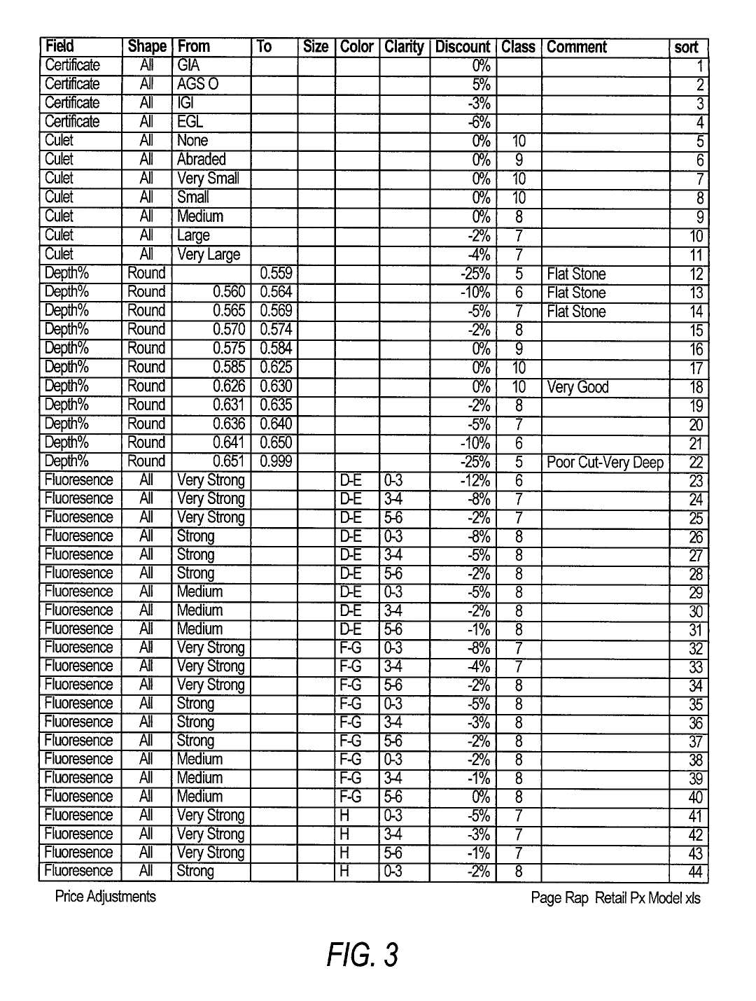

The buyer can then access any computer terminal connected to a global network of interconnected computers, e.g., the Internet, launch a web browser and access a web site on the World Wide Web, and see on a monitor screen connected to the buyer's computer terminal a web page resembling that depicted in FIG. 1. The user is prompted to enter as many of the parameters of which he has knowledge, after which the entered parameters are sent to a server which accesses a first database, a portion of which is depicted in FIG. 3.

The server retrieves a suggested transaction price from the first database based on the entered parameters. In addition, the suggested transaction price is adjusted based on expert assessments to obtain an adjusted price. The column marked “Discount” indicates the percentage adjustment to the suggested transaction price based on an expert's opinion of the worth of the cut and quality of a diamond having the entered parameters.

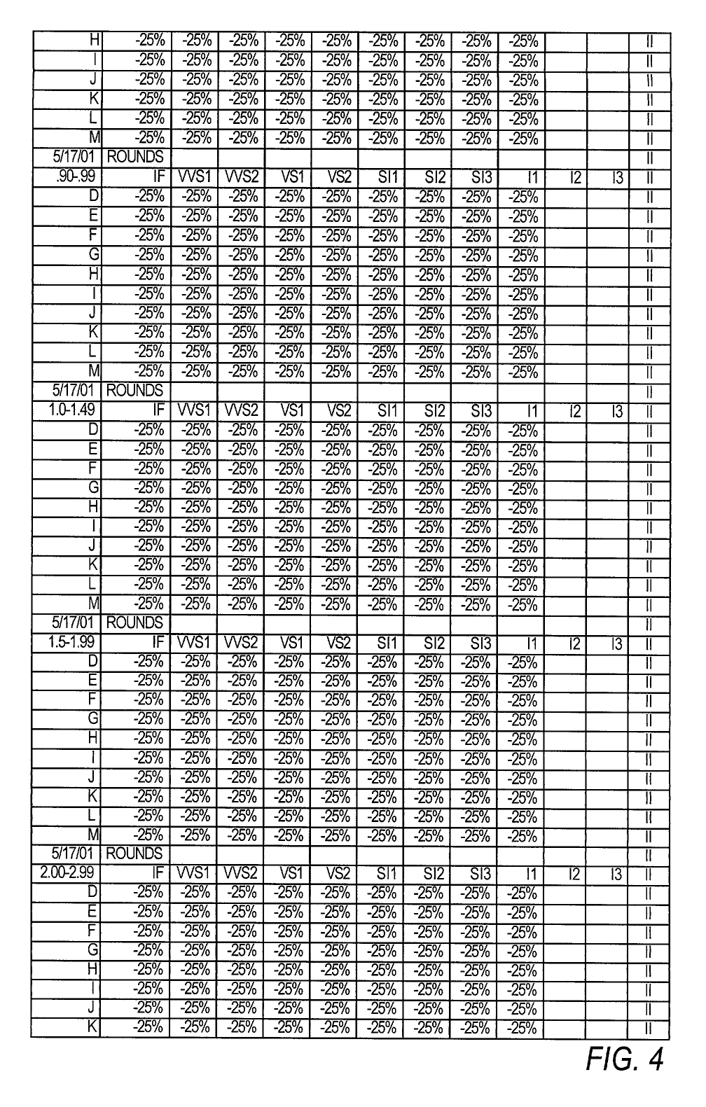

The server may also access a second database, a portion of which is depicted in FIG. 4, for an additional price adjustment, again based on an expert assessment, this time of the market conditions and the market locations. Market location is important because a buyer in a foreign country may buy a diamond at a much lower discount than a U.S. buyer.

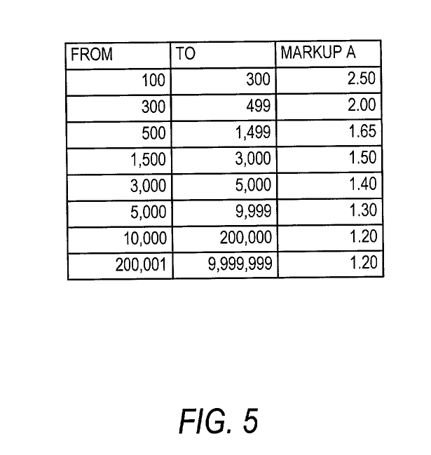

The server may also access a third database, a portion of which is depicted in FIG. 5, for an additional price adjustment, again based on an expert assessment, this time of the retail markup in certain markets based on the wholesale adjusted price of the diamond. For example, FIG. 5 indicates that a diamond worth between $3,000.00 to $5,000.00 is marked up by a factor of 1.4 from the wholesale price to obtain the retail price.

All of the above databases can be combined in a single database and accessed by a single server. The adjusted retail price is then compared with the quoted price to obtain a transaction value. The difference between the adjusted and quoted prices measures the value. The larger the positive difference, the greater the value and the better deal or bargain is being offered to the buyer.

The transaction value for the first transaction or proposed diamond purchase is then stored in a memory location, typically, a password-protected site accessible solely to the buyer. Before entry of the above parameters to obtain the first transaction value, the buyer subscribes to a service provider to establish the site, to gain access to the above-described proprietary databases, and to store the first transaction value.

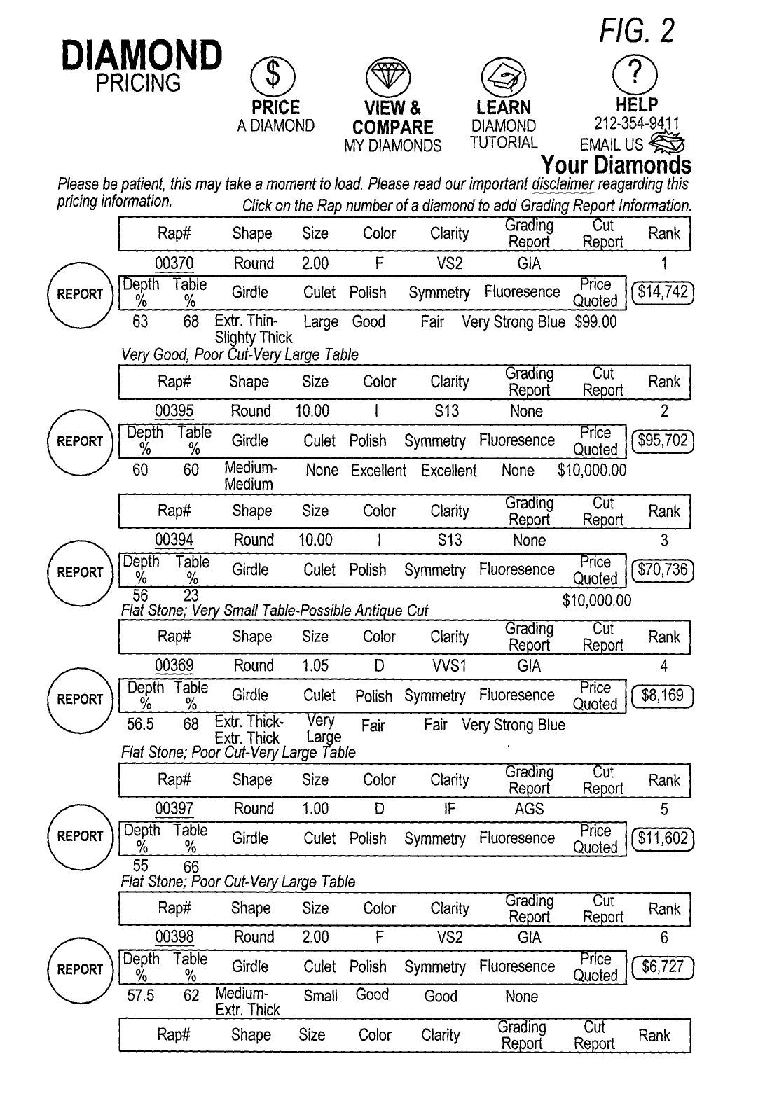

The buyer repeats the above steps for additional transactions, each time resulting in a transaction value being stored in the memory location at the site for each transaction. At the buyer's request, or automatically, all the transaction values are ranked in order of their worth and displayed on the monitor screen of the buyer's computer terminal in a manner depicted in FIG. 2. The buyer then can see at a glance which transaction has the greatest worth.

In the practice of this invention, different transactions are entered. For example, different diamonds, or other items of personal or real property, can be appraised of their worth based on expert assessments, and then their respective worths compared and ranked. The items to be compared need not be of the same category. For example, a buyer having a certain sum of money to spend may want to know if a better deal exists between a diamond, on the one hand, and a car, on the other hand.

It will be understood that each of the elements described above, or two or more together, also may find a useful application in other types of constructions differing from the types described above.

While the invention has been illustrated and described as embodied in an on-line system and method of ranking diamonds, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A method of ranking transactions in order of their value, comprising the steps of:
a) entering parameters concerning a first transaction in a database served by an on-line global network of interconnected computers, and retrieving from the database a suggested price for the first transaction based on the entered parameters;
b) adjusting the suggested price based on expert assessment to obtain an adjusted price for the first transaction;
c) comparing the adjusted price with a quoted price to obtain a transaction value for the first transaction;
d) storing the transaction value for the first transaction;
e) repeating steps a) through d) for other transactions to create a store of transaction values for multiple transactions;
f) ranking the transaction values in the store in order of their value; and
g) communicating the ranking of the transaction values to a consumer.

2. The method of claim 1, wherein the entering step is performed at a keyboard of a computer connected to the network, and wherein the displaying step is performed by displaying the ranking on a monitor of the computer.

3. The method of claim 1, wherein the entering step is performed by entering at least one parameter from a group including shape, size, color and clarity of a gemstone.

4. The method of claim 3, wherein the gemstone is a diamond, and wherein the group further includes a grading report.

5. The method of claim 1, wherein the adjusting step is automatically performed without manual intervention by the consumer.

6. The method of claim 1, wherein the expert assessment includes considering at least one factor from a group including trade discount, trade mark-up, market condition and market location.

7. The method of claim 1, and further comprising entering the quoted price by the consumer.

8. The method of claim 1, wherein the store of ranking values is created at a reserved site on the network.

9. The method of claim 1, wherein the transactions are from a single category of goods.

10. The method of claim 1, wherein the transactions are from different categories of goods.

11. A system for ranking transactions in order of their value, comprising:
a) a server connected to an on-line global network of interconnected computers, the server being operatively connected to a database;
b) a personal computer operated by a consumer, and having means for enabling parameters concerning respective transactions to be entered in the database;
c) the server being operative, for each transaction, for retrieving from the database a suggested price for the transaction based on the entered parameters, for adjusting the suggested price based on expert assessment to obtain an adjusted price for the transaction, for comparing the adjusted price with a quoted price to obtain a transaction value for the transaction, for storing the transaction value for the transaction in a memory, and for ranking the transaction values in order of their value; and
d) a display operatively connected to the computer, for displaying the ranking of the transaction values to the consumer.
